(19) United States
(12) Patent Application Publication
(10) Pub. No.: US 2015/0138848 A1
(43) Pub. Date: May 21, 2015

(54) SYSTEM AND METHOD TO REDUCE THE ENERGY STORAGE REQUIREMENTS OF A CASCADED CONVERTER SYSTEM

(71) Applicant: THE GOVERNING COUNCIL OF THE UNIVERSITY OF TORONTO, Toronto (CA)

(72) Inventors: Damien F. Frost, Toronto (CA); Peter Lehn, Toronto (CA); Aleksandar Prodic, Toronto (CA)

(21) Appl. No.: 14/406,361

(22) PCT Filed: Jun. 10, 2013
(86) PCT No.: PCT/CA2013/050438

§ 371 Date: Dec. 8, 2014

Related U.S. Application Data
(60) Provisional application No. 61/657,187, filed on Jun. 8, 2012.

(51) Int. Cl. H02M 1/42; H02M 3/335

(52) U.S. Cl. CPC H02M 1/4208; H02M 3/33523; H02M 3/33515
USPC 363/21.12; 363/21.01

(57) ABSTRACT

A method and system for controlling a cascaded converter has an upstream converter and a downstream converter coupled in series. An energy storage element is provided between the two converters for providing constant energy and to respond to a load step in the load of the system. An upstream controller is connected to the output of the downstream controller to control the duty cycle of the upstream converter as a function of the duty cycle of the downstream controller. The upstream converter controls the duty cycle of the upstream converter in order to maintain the duty cycle of the second converter at a substantially constant reference value. This control of the converters allows for reduction of the energy storage requirements of the cascaded system.

### FIELD

Embodiments described herein relate generally to a cascaded converter system.

### INTRODUCTION

Voltage and current converters are widely used in electronics, aviation and other applications. Cascaded converter systems provides one arrangement for such conversion. Where the voltage or current source is an AC source, one of the converters in the cascade my provide power factor correction. Current designs of such cascaded converters are subject to various limits and trade-offs.

### SUMMARY

The embodiments described herein provide in one aspect a cascaded converter system comprising: a first converter; a second converter coupled in series to the first converter; a first controller having an input and an output, the input being coupled to an output of the second converter and the output being coupled to an input of the second converter, the first controller controlling the voltage or current being supplied to the input of the second converter; a second controller having an input and an output, the input of the second controller being coupled to the output of the first controller and the output of the second controller being coupled to the input of the first converter, the second controller controlling the voltage or current being supplied to the input of the first converter.

The coupling of the input of the second controller to the output of the first controller allows for control of the two converters that further allows reduction of the energy storage requirements in the cascaded converter system.

Further aspects and advantages of the embodiments described will appear from the following description taken together with the accompanying drawings.

### DRAWINGS

The drawings included herewith are for illustrating various examples of articles, methods, and apparatuses of the present specification and are not intended to limit the scope of what is taught in any way. These and other features of exemplary embodiments will become more apparent from the following description in which reference is made to the appended drawings wherein:

FIG. 1 is a schematic circuit diagram of a prior art cascaded converter system;

FIG. 2 is a schematic circuit diagram of a reduced-energy storage cascaded converter system;

FIG. 3 is a schematic diagram of two arrangements for coupling cascaded buck converters;

FIG. 4 is a graph of simulation results of the voltage at the outputs of a conventional cascaded converter system and a reduced-energy storage cascaded converter system in response to a step command;

FIG. 5 is a graph of a ripple current in the energy storage capacitor;

FIG. 6 is a graph of a graph of AC power absorbed by an energy storage capacitor;

FIG. 7 is a schematic circuit diagram of a preferred embodiment of the reduced-energy storage cascaded converter system;

FIG. 8 is a graph showing the input voltage and current under full load according to an experimental implementation of the reduced energy storage cascaded system;

FIG. 9 is a graph showing the voltage on the energy storage capacitor, the output voltage and the duty cycle of the flyback converter according to an experimental implementation of the reduced energy storage cascaded system;

FIG. 10(a) is a graph showing the measured power factor according to an experimental implementation of the reduced energy storage cascaded system;

FIG. 10(b) is a graph showing the measured power factor according to an experimental implementation of the reduced energy storage cascaded system;

FIG. 11 shows the odd harmonics over loads according to an experimental implementation of the reduced energy storage cascaded system;

FIG. 12(a) shows the transient response of the converter system according to an experimental implementation of the reduced energy storage cascaded system;

FIG. 12(b) shows the transient response of the converter system according to an experimental implementation of the reduced energy storage cascaded system;

FIG. 13 shows a waveform entering the current sensing ADC according to an experimental implementation of the reduced energy storage cascaded system;

### DESCRIPTION OF VARIOUS EMBODIMENTS

Various systems or methods will be described below to provide an example of an embodiment of each claimed invention. No embodiment described below limits any claimed invention and any claimed invention may cover systems and methods that differ from those described below. The claimed inventions are not limited to systems and methods having all of the features of any one systems or method described below or to features common to the systems or methods described below. It is possible that a system or method described below is not an embodiment of any claimed invention. Any invention disclosed in an systems or method described below that is not claimed in this document may be the subject matter of another protective instrument, for example, a continuing patent application, and the applicant(s), inventor(s) and/or owner(s) do not intend to abandon, disclaim or dedicate to the public any such invention by its disclosure in this document.

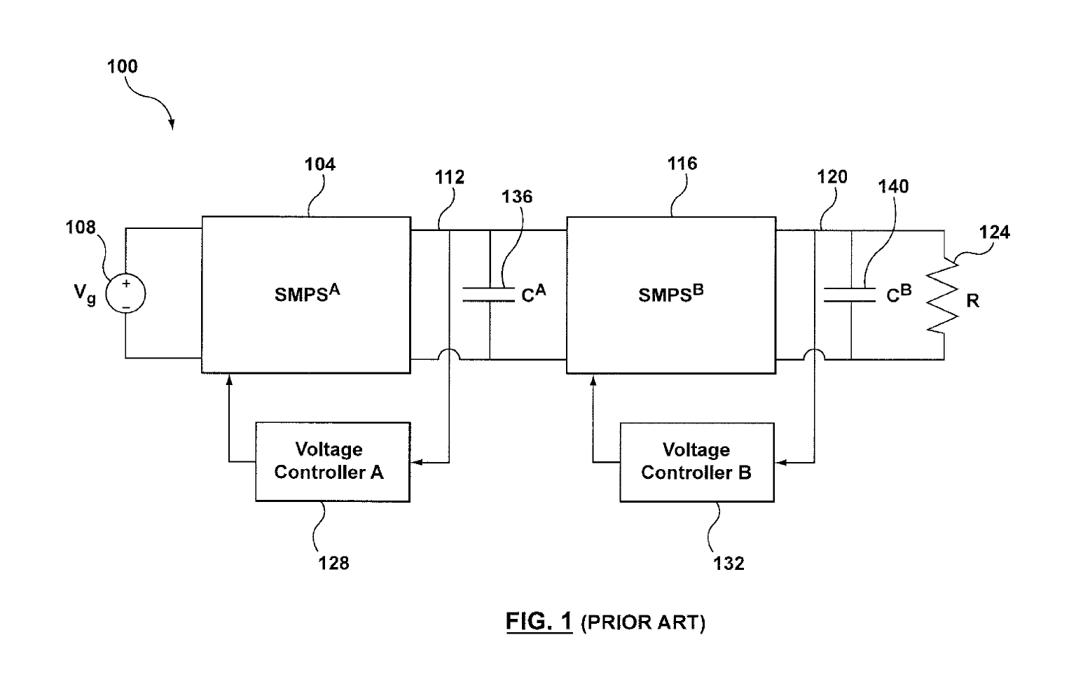

Referring to FIG. 1, therein illustrated is a schematic circuit diagram of a known prior art cascaded converter system 100. For example, the cascaded converter system may be used as an AC-DC (alternating current-direct current) rectifier providing close to unity power factor correction.

According to an AC-DC rectifier configuration, the upstream converter 104, which may be a switched-mode power supply (SMPS), converts the voltage provided by AC input source 108 to provide a DC voltage output at the output 112 of the upstream converter 112. The input source 108 is shown as an AC voltage source (Vg) but may also be an input current source. The downstream converter 116, which may also be a SMPS, can be a DC/DC converter to convert the voltage at the output 112 to provide a desired DC voltage output at the downstream converter output 120 to a load 124. According to certain embodiments, a typical diode bridge may be provided to be coupled in series between the input source 108 and the input of the upstream converter 104.

According to prior art cascaded converter system 100, the upstream converter 104 has a controller 128, which may be a voltage controller or current controller, connecting the output 112 of the upstream converter 104 to an input of the upstream converter to control the current or voltage being supplied to the upstream controller 104 in order for the upstream converter to output the desired level, voltage or current, at the output 112. Similarly the downstream converter 116 has a controller 132, which may be a voltage controller or current controller, connecting the output 120 of the downstream converter 116 to an input of the downstream controller 116 in order for the downstream converter to output the desired level, voltage or current, at the output 124 to the load 124.

Since the input source 108 is AC, which is typically sinusoidal, the input power is pulsating at twice the frequency of the input source 108. For example, in a single phase unity power factor AC/DC conversion, the power may be represented by the equation:

$$P ( t ) = {V}_{g} cos ( ω t ) {I}_{g} cos ( ω t ) = \frac{{V}_{g} {I}_{g}}{2} ( 1 + cos ( 2 ω t ) ) \qquad ( 1 )$$

However, since the power demanded by the load is to be constant, an energy storage element is required. For example, during times when the input power is less than the output power, the upstream converter 104 must have sufficient energy to supply the downstream converter 116 and the load 124. In voltage applications, the energy storage is supplied with a capacitor 136 that is coupled in series between the upstream converter 104 and the downstream converter 116. Moreover, the energy storage element 136 is useful for providing energy when there is a load step, i.e. a change in the load 124. For example, a second energy storage device 140 may also be coupled at the output of the downstream converter 116 for providing energy when there is a change in the load step of load 124.

For example, the sequence of events during a load step increase at the load 124 would be the following:

1. Load step increase occurs;
2. Output voltage of downstream converter 116 drops;
3. Voltage controller 132 of downstream converter increases duty cycle of downstream converter 116;
4. Input current of downstream converter 116 increases;
5. Output voltage of upstream converter drops as the capacitor 136 is discharged;
6. Voltage controller 128 of upstream converter 104 increases duty cycle of upstream converter 104 to provide additional energy to charge the capacitor 136.

It will be appreciated that at steps 4 and 5, the energy storage element 136 plays an important role in providing sufficient energy to the downstream converter 116. Moreover, since the voltage controller 128 is connected to the upstream converter output 112, current or voltage being supplied to the upstream converter 104 is controlled only after the energy storage element 136 has begun discharging and exhibits a drop in the output voltage. Consequently, to ensure that sufficient energy is stored in the energy storage element 136, that energy is provided quickly to the load, and that the voltage of the energy storage element 136 does not exhibit drastic changes, the energy storage element 136 must be sufficiently large. Where the energy storage element 136 is a capacitor, it must be very large, which results in it being costly and bulky. Furthermore the energy storage capabilities of the capacitor 136 are underutilized.

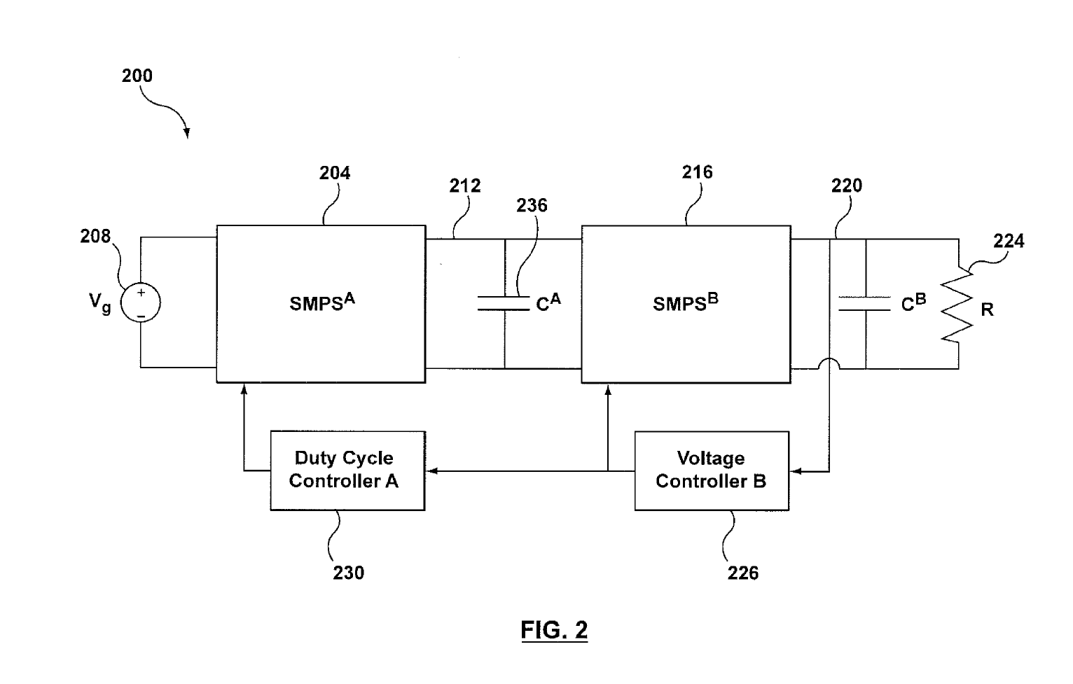

Referring now to FIG. 2, therein illustrated is a schematic circuit diagram of an exemplary embodiment of a cascaded converter system with reduced energy storage requirements 200.

The reduced-energy storage cascaded converter system 200 comprises an upstream converter 204, which may be a switched-mode power supply (SMPS). The upstream converter 204 converts the voltage or current supplied by an input source 208 to provide a desired DC current or voltage at the upstream converter output 212. The output 212 of the upstream converter 204 is coupled in series with an input of a downstream converter 216. The downstream converter 216, which may also be a SMPS, can be an DC/DC converter to convert the current or voltage outputted by the upstream converter 216 to provide a desired DC voltage or current at the downstream converter output 220 to a load 224. According to certain embodiments, a typical diode bridge may be provided to be coupled in series between the input source 208 and the input of the upstream converter 204.

The reduced-energy storage cascaded converter system 200 comprises a downstream controller 226 that has its input being coupled to the downstream converter output 220 and its output being coupled to an input of the downstream converter 216. The downstream controller 226 controls the voltage or current that is supplied from the output of the downstream converter 216. For example, the downstream controller 226 controls a switch at the input of the downstream converter to control the amount of input voltage or input current being supplied to the downstream converter 216. Control of the switch effectively controls the duty cycle of the downstream converter 216. For example, the downstream controller 226 may be configured to ensure that the downstream converter 216 maintains a substantially constant desired duty cycle, or reference duty cycle.

The reduced-energy storage cascaded converter system 200 further comprises an upstream controller 230 that has its input being coupled to the output of the upstream controller 226 and its output being coupled to the input of the upstream converter 204. For example, the upstream controller 230 controls a switch at the input of the upstream converter 204 to control the amount of input current or input voltage being supplied to the downstream converter 216. Control of the switch effectively controls the duty cycle of the downstream converter 216. In particular, the upstream controller 230 controls the voltage or current being supplied to the upstream converter 204 as a function of the duty cycle of the downstream converter 216 being controlled by the downstream controller 226. For example, the upstream controller 230 may control voltage or current being supplied from the upstream converter 204 such that the downstream converter 216 maintains a substantially constant desired duty cycle, or reference duty cycle.

The reduced-energy storage cascaded converter system 200 further comprises an energy storage element 236 coupled in series between the upstream converter 204 and the downstream converter 216. As described above in relation to the prior art cascaded converter system 100, the energy storage element 236 stores energy, which can then be used to provide a substantially constant voltage or current to the load 224 coupled to the downstream converter output 220. For example, as shown in FIG. 2, the energy storage element 236 may be a capacitor. Alternatively, the energy storage element 236 may be an inductor, which can be used where the reduced-energy storage cascaded converter system 200 is a current converter. As will be described below, the configuration of the upstream controller 230 and the downstream controller 226 allows the energy storage requirements of the energy storage element 236 to be substantially reduced.

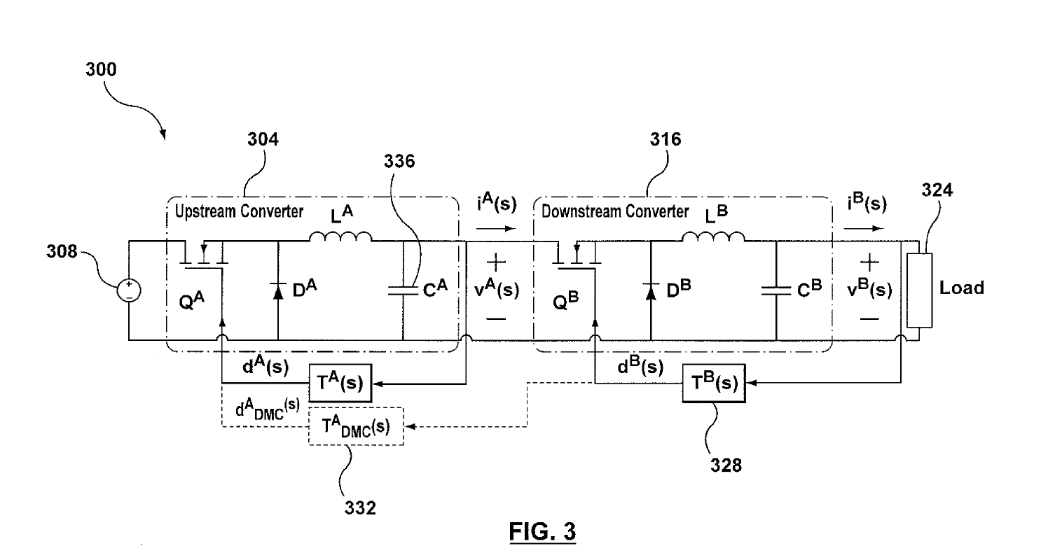

Referring now to FIG. 3, therein illustrated is a schematic circuit diagram for coupling cascaded converters according to a conventional arrangement of the reduced-energy storage cascaded arrangement. For example, a conventional cascaded system containing an upstream buck converter 304 in cascaded arrangement with downstream buck converter 316 is shown with an upstream controller 324 connecting the output of the upstream buck converter 304 with the input of the upstream buck converter 304 and a downstream controller 328 connecting the output of the downstream buck converter 316 with an input of the downstream buck converter 316. The upstream controller 324 has a transfer function T^{A}(s). The downstream controller 328 has a transfer function T^{B}(s). Where both converters are operating with voltage mode control, the output over time of its downstream controller 332 corresponds to the duty cycle of the downstream converter 316. This is expressed in Equation 2:

d^{B}(s)=T^{B}(s)v^{B}(s) (2)

where d^{B}(s) is the duty cycle of the downstream buck converter 316 and v^{B}(s) is the voltage at the output of the downstream buck converter 316.

Using the small signal approximation, the input current into the downstream buck converter 316 is proportional to the dc current in through the converter 316:

i^{A}(s)=l^{B}d^{B}(s) (3)

where l^{B} is the output current at the downstream buck converter 304 and i^{A}(s) is the output current of the upstream buck converter.

Substituting Equation 2 into Equation 3:

i^{A}(s)=l^{B}T^{B}(s)v^{B}(s) (4)

The input voltage to the downstream buck converter 316 is related to its current through the energy storage capacitor, C^{A} 336. Thus, v^{A}(s) can be determined by substituting Equation 3 into the ideal capacitor equation to yield:

$${v}^{A} ( s ) = \frac{{I}^{B} {T}^{B} ( s ) {v}^{B} ( s )}{{sC}^{A}} \qquad ( 5 )$$

Finally, the duty cycle of the upstream buck converter 304 is determined by multiplying its output voltage by its upstream controller 324's transfer function:

$${d}^{A} ( s ) = \frac{{I}^{B} {T}^{A} ( s ) {T}^{B} ( s ) {v}^{B} ( s )}{{sC}^{A}} \qquad ( 6 )$$

wherein d^{A}(s) is the duty cycle of the upstream buck converter 304.

Continuing with FIG. 3, the conventional cascaded converter system 300 may be modified by removing the upstream controller 324 (shown in solid lines) and placing an upstream duty mode controller 332 (shown in perforated lines) that has its input connected to the output of the downstream controller 328 and its output connected to the input of the upstream converter 304. The upstream duty mode controller has a transfer function T^{A}_{DMC}(s). A similar equation representing duty cycle control by the upstream duty mode controller 328 can be derived by simply multiplying the duty cycle of Equation 2 by the duty mode controller 330 transfer function:

d_{DMC}^{A}(s)=T_{DMC}^{A}(s)T^{B}(s)v^{B}(s) (6)

It will be appreciated from equations 5 and 6 that according to the reduced-energy storage cascaded converter system 200, any change in the output of the downstream converter 316 is more directly communicated to the upstream converter 304. In particular, communication of effects at the output of the downstream converter 316 to the upstream converter 304 is not primarily reliant on a change in the voltage in the energy storage element 336. It will be further understood that while the above duty cycle of the upstream converter has been calculated with respect to a two buck converter cascaded arrangement, a similar calculation may be applied to any cascaded converter system wherein the upstream controller is directly coupled to the output of the downstream controller. For example, the same calculation of the duty cycle of upstream converter 204 as a function of the duty cycle of the downstream converter 216 may be applied to the reduced energy storage cascaded converter system 200 as shown in FIG. 2.

Referring back to FIG. 2, for example, the sequence of events during a load step increase in the load 224 in the reduced-energy storage cascaded converter system 200 would be the following:

1. Load step increase occurs;
2. Output voltage of downstream converter 216 drops;
3. Downstream controller 226 increases duty cycle of downstream converter 216;
4. Upstream controller 230 increases duty cycle of upstream converter 204 to provide additional energy.

It will be appreciated that since input of the upstream controller 230 is coupled to the output of the downstream controller 226, it can respond immediately to a change in the voltage or current at the output of the downstream converter 216 to effect a corresponding change in the voltage or current being supplied from the output of the upstream converter 204. The upstream controller 230 may also respond immediately to a change in the duty cycle of the downstream converter 216 to effect a corresponding change in the duty cycle of the upstream converter 204. It will be understood that the corresponding change described herein should not be limited to a change that is identical to the change at the output of the downstream converter 216, but includes a change that is a function of the change at the output of the downstream converter 216. In particular, the change to the voltage, current or duty cycle of the upstream converter 204 may be different from the change at the output of the downstream converter 216, but is made to maintain the duty cycle of the downstream converter 216 at a reference value.

In particular, unlike the conventional cascaded converter system 100, since the upstream controller 230 receives information pertaining to the duty cycle of the downstream converter 216, the upstream controller 230 does not need to sense a change in the current or energy across the energy storage element 236. For example, in a load step increase, the system does not have to wait until the input current of downstream converter 216 increases and the output voltage of upstream converter 204 drops as the capacitor 236 is discharged in order to start controlling the duty cycle of the upstream converter 230 in response to the load step change at the load 224.

By coupling the input of the upstream converter 230 to the output of the downstream controller 226, the upstream converter 230 can respond to the load step change significantly faster than any change of voltage or current in the energy storage device 236. As a result, steps 4 and 5 of the sequence of events for responding to a load step increase according to the conventional cascaded converter system can be skipped. It will be appreciated that these steps were the ones which depended on the properties and operation of the energy storage element 236. As a result, the properties of the energy storage element 236 are no longer critical to the reduced energy storage cascaded converter system 200. Therefore, the energy storage requirements of the energy storage element 236 can be reduced while still ensuring that the upstream control responds sufficiently quickly to maintain the desired voltage or current in the energy storage element 236 in response to a change in load 224.

For example, where the energy storage element 236 is a capacitor, the capacitor may be selected to be a low energy storage capacitor when implemented in the reduced-energy storage cascaded converter system 200. Accordingly, cheaper and/or smaller capacitors such as film, ceramic or electrolytic capacitors may be used. For example in consumer converters, the low energy storage capacitor may have a size in the range of 56 to 100 micro-farads for a converter with an input voltage of 110VRMS and an output voltage of 12 VDC supplying a 40W load. For a cascaded system where the input voltage 208 of FIG. 2 is a DC voltage or current source, the low energy storage capacitor may have a size in the range of 5 to 100 micro-farads for a converter with an input voltage of 110 VDC and an output voltage of 12 VDC supplying a 40W load. The energy storage element 236 may be further reduced in size for when the input source 208 is a DC source because the input power never drops to zero as it does for AC sources.

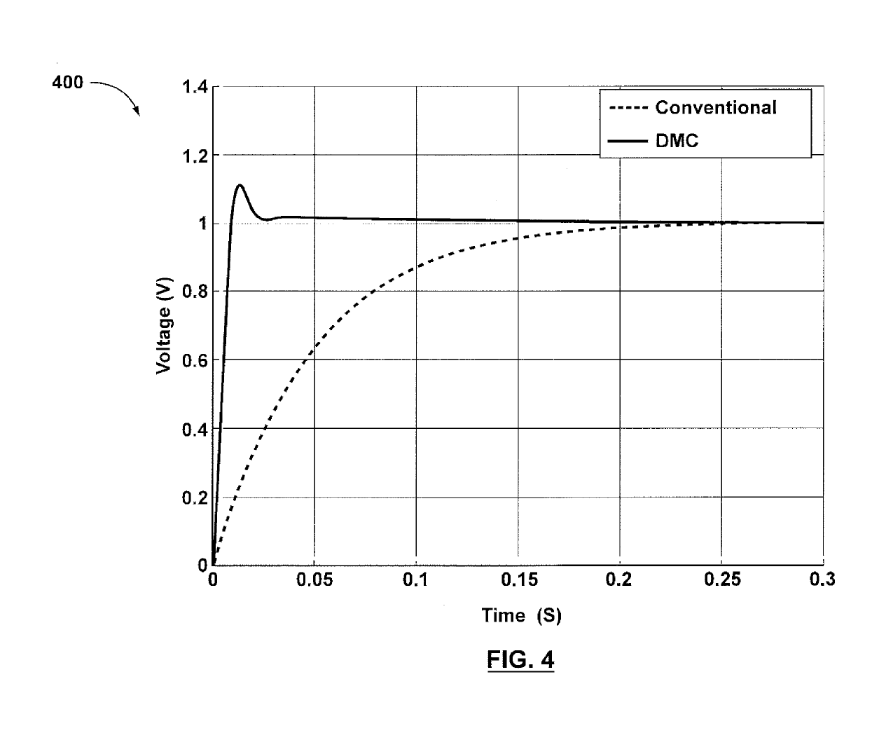

Referring now to FIG. 4, therein shown is a graph 400 of the simulation results of the voltage at the downstream converter output 120 of the prior art cascaded converter system and the downstream converter output 220 of the reduced energy storage cascaded converter system, both in response to a voltage step increase command at the output. For this simulation, the downstream converter 116 of the prior art cascaded converter system is identical to the downstream converter 216 of the reduced energy storage cascaded converter system and the downstream controller 132 of the prior art cascaded converter system is identical to the downstream controller 226 of the reduced energy storage cascaded converter system 200. It will be appreciated that the prior art cascaded converter system upon sensing the voltage step increase command of 1V, immediately draws more energy from the energy storage element 136. As a result, the voltage of the main energy storage element 136 drops, and it is unable to quickly drive more power into the downstream converter 116.

By contrast, the reduced energy storage cascaded converter system 200 exhibits a step-like response. In particular, it will be appreciated that the output voltage reaches the desired 1V level significantly faster than the conventional cascaded converter system. This is accomplished since upon sensing the voltage step increase command of 1V, the reduced energy storage cascaded converter system 200 immediately drives more power into the energy storage element 236. This helps drive the output voltage 224 to its new desired operating point. Moreover, it will be appreciated that the voltage response is not dependent on a change in the voltage or current of the energy storage element 236. It will also be appreciated that the upstream controller 230 controls a change in the voltage or current being supplied to the first converter 204 substantially faster than a change of voltage or current in the energy storage element 236 in response to the change in load step.

According to some exemplary embodiments of the reduced-energy storage cascaded converter system 200, both the upstream controller 230 and the downstream controller 226 can be implemented using digital devices. Advantageously, digital control permits the use of control techniques that would be difficult or impossible to implement with standard analog control, such as dead zone control and dead beat control. Furthermore, one or more analog-to-digital converters may be used to provide digital signals to the upstream controller 230 or the downstream controller 226. For example, at least an analog-to-digital converter may be placed between the downstream converter output 220 and the input of the downstream controller 226 to provide the output voltage or current digitally to the downstream controller 226.

In particular, using digital control allows the upstream controller 230 to be implemented as a duty cycle controller, referred herein as duty mode control (DMC). DMC regulates a duty cycle to a desired value. Using DMC, the voltage or energy on the energy storage element 236 will be controlled such that the duty cycle of the downstream converter 216 is held at a reference value. By contrast, a typical controller controls the voltage as a function of the output voltage or current of the converter that it is controlling.

Advantageously, the coupling of the upstream controller 230 with the downstream controller 226 allows both controllers to be implemented as a single centralized controller. For example, the two controllers may be implemented on a single field programmable gate array (FPGA) or microcontroller.

According to some exemplary embodiments, the reduced-energy storage cascaded converter system 200 may be a DC-DC converter, wherein the upstream converter 204 steps down the voltage or current of the input source 208 to a first intermediate voltage or current at the upstream converter output 212 and the downstream converter 216 further steps down the intermediate voltage or current to the desired voltage or current at the downstream converter output 220 to be provided to the load 224.

According to some exemplary embodiments, the reduced-energy storage cascaded converter system 200 may be an AC-DC rectifier that converts input AC voltage or current from input source 208 to a desired DC voltage or current at the downstream converter output 220 to be provided to the load 224. For example, the upstream converter 204 may be selected to provide a desirable power factor correction and the downstream converter 216 may be a suitable DC-DC converter. For example, the downstream converter may be a non-isolated DC-DC converter providing load voltage or current regulation.

According to some exemplary embodiments, the reduced energy storage cascaded converter system 200 may be a DC-AC inverter that converts an input DC voltage or current from the input source 208 to a desired AC voltage or current. In one exemplary embodiment, the DC voltage source 208 is a solar photovoltaic array or solar photovoltaic panel, the load 224 would be replaced by the solar photovoltaic array or solar photovoltaic panel. The downstream converter 216 would be selected to provide maximum power point tracking of the solar photovoltaic array or solar photovoltaic panel. The upstream converter 204, may be selected to be a DC-AC inverter that converts the DC voltage from the output of the downstream converter 216 to AC voltage or current.

As described above, the reduced-energy storage cascaded converter system 200 allows the energy storage requirements of the energy storage element 236 to be significantly reduced. For example, where the energy storage element is a capacitor and the converter is either an AC-DC rectifier or DC-AC inverter, slightly more stress will be put onto the energy storage capacitor 236 as a result of the reduction in energy storage capability. The increased stress will manifest itself through a combination of an increased ripple current on the capacitor, and an increased peak voltage on the capacitor. Two equations may be derived to help select a suitable capacitor size to manage these stress factors.

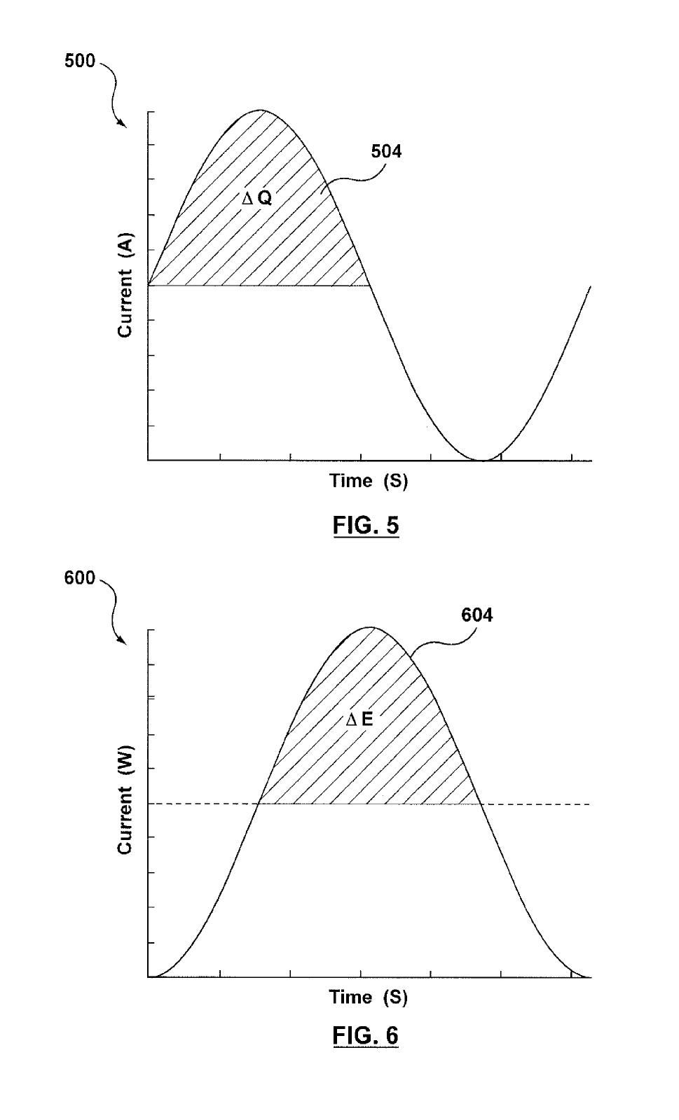

Referring to FIG. 5, therein illustrated is graph of a ripple current in the energy storage capacitor 236. This current can be approximated to be a sinusoidal current with a peak amplitude of \sqrt{2}lᵣ. The shaded region 504 represents the amount of charge ΔQ deposited on the capacitor after t=0 when the current is positive. This charge is added to the charge residing on the capacitor when it is at its lowest voltage, V_{MIN}. Therefore the maximum voltage on the capacitor is given by Equation (X):

$${V}_{MAX} = \frac{{Q}_{MIN} + Δ Q}{C} \qquad ( 7 )$$

where Q_{MIN} is the charge on the capacitor initially at t=0 and C is the capacitance. Defining ΔV_{T}=V_{MAX}−V_{MIN} it may be determined that:

$$Δ {V}_{r} = \frac{Δ Q}{C} \qquad ( 8 )$$

Integrating the current over one half cycle to obtain ΔQ yields:

$$Δ Q = \frac{\sqrt{2} {I}_{r}}{π {f}_{r}} \qquad ( 9 )$$

where fᵣ is the frequency of the second harmonic of the system. Substituting Equation (9) into Equation (8) the peak to peak ripple voltage on the capacitor is obtained in Equation (10).

$$Δ {V}_{r} = \frac{\sqrt{2} {I}_{r}}{π {f}_{r} C} \qquad ( 10 )$$

Next, in an ideal PFC circuit, the current and voltage waveforms are sinusoidal and in phase with each other. Therefore an expression for the instantaneous input power may be obtained:

$${P}_{in} ( t ) = {V}_{g} cos ( ω t ) {I}_{g} cos ( ω t ) = \frac{{V}_{g} {I}_{g}}{2} ( 1 + cos ( 2 ω t ) ) \qquad ( 11 )$$

where ω is the frequency of the input source 208.

Equation (11) can be separated into a dc and ac component yielding:

Pᵢₙ(t)=P_{dc}+P_{ac}(t) (12)

where,

$$\begin{matrix}{P}_{dc} = \frac{{V}_{g} {I}_{g}}{2} \\ and & ( 13 ) \\ {P}_{ac} ( t ) = \frac{{V}_{g} {I}_{g}}{2} cos ( 2 ω t ) = {P}_{dc} cos ( 2 ω t ) & ( 14 )\end{matrix}$$

Assuming that the AC component of the input power is absorbed completely by the energy storage capacitor 236, the ripple on the capacitor that will result in this oscillating power may be determined. This assumption is valid as long as the energy stored in the other energy storage components is negligible. For a flyback converter, this means the energy stored in the magnetizing inductance is much smaller than the energy stored in the capacitor 0.5Lₘlₘ²<<0.5C₁V_{C}²

Referring now FIG. 6, therein illustrated is a graph of the AC power absorbed by the storage capacitor 236. The shaded region 604 in FIG. 6 represents the energy absorbed by the capacitor 236 for one half cycle. This absorption of energy will increase the capacitor voltage according to Equation (10), Let this energy be called LE.

$$Δ E = \frac{1}{2} C ( {V}_{f}^{2} - {V}_{i}^{2} ) \qquad ( 15 )$$

where V_{f}, Vᵢ and C are the final capacitor voltage, initial capacitor voltage and the capacitance, respectively.

Integrating the ac power over a half cycle to obtain ΔE yields:

$$Δ E = \frac{{P}_{dc}}{ω} \qquad ( 16 )$$

Substituting Equation (16) into Equation (15) and letting Vᵢ=V_{MAX}−ΔVᵣ and V_{f}=V_{MAX}:

$${P}_{dc} = \frac{1}{2} C ω ( 2 {V}_{MAX} Δ {V}_{r} - Δ {V}_{r}^{2} ) \qquad ( 17 )$$

Finally substituting Equation (10) into Equation (17) for ΔVᵣ yields the final result:

$${P}_{dc} = \sqrt{2} {V}_{MAX} {I}_{r} - \frac{{I}_{r}^{2}}{π {f}_{r} C} \qquad ( 18 )$$

Equation (18) is the first design equation that may be used for the reduced-energy storage cascaded converter system 200. It is an expression for the maximum DC power that can be drawn from an AC input source 208 at unity power factor while effectively filtering out the AC ripple power using an energy storage capacitor 236 to its designed limits. This equation may be useful when using electrolytic capacitor technology, which will be limited by its ripple current rating.

The second design equation comes from solving Equation 10 for lᵣ, substituting the result into Equation 18 and solving for the capacitance, C:

$$C = \frac{{P}_{dc}}{{V}_{MAX} Δ {V}_{r} π {f}_{r} - {( Δ {V}_{r} )}^{2} π {f}_{r} / 2} \qquad ( 19 )$$

Equation 19 is an equation that may be used to indicate the minimum capacitance value required to effectively filter out the AC power from a unity power factor pre-regulator. This equation is useful when using thin film technology, where the size of the capacitor will be the limiting design factor.

While the above analysis provided to exemplary indications of maximum power to be drawn and minimum capacitance value, according to some exemplary a filter may be implemented within the integrated circuit for the upstream controller 230 and downstream controller 226 for filtering the voltage ripples. For example, the filter may be a finite impulse response filter.

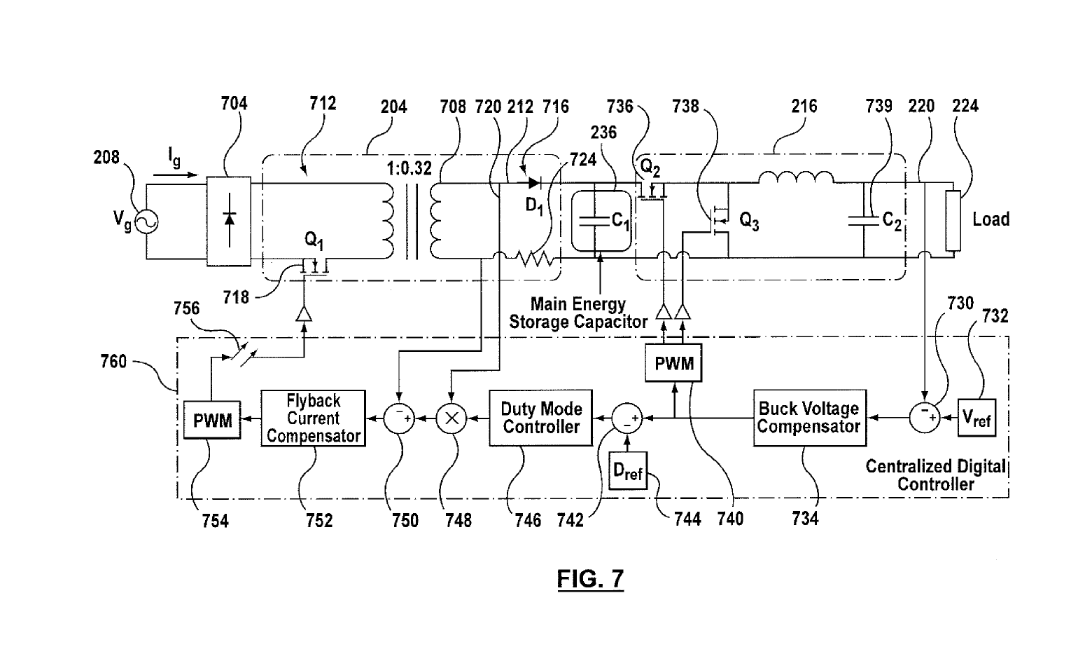

Referring now to FIG. 7, therein illustrated is a schematic circuit diagram of a preferred embodiment of the reduced-energy storage cascaded converter system 200 for providing an AC-DC rectifier. According to this embodiment, the upstream converter 204 is selected to be a flyback converter. A diode bridge 704 couples the input source 208 to the input of the upstream converter 204.

The flyback converter 204 provides high power factor correction, which in some cases may be near unity. The flyback upstream converter 204 comprises a transformer 708 which separates the converter into a first side 712 on the input side of the transformer 608 and a second side 716 on the output side of the transformer 708. The first side 712 is in galvanic isolation from the second side 716. The turns ratio of the transformer 708 of the flyback upstream converter 204 is selected to provide a desired step down in voltage. According to some exemplary embodiments, the turns ratio can be 1:0.32. A upstream converter switch 718 is located on the first side 712. The switch 718 is coupled to the output of the upstream controller 230 and controlled by the upstream controller 230 to selectively feed power to the upstream converter 204.

According to some exemplary embodiments, a voltage sensor 720 may be located on the second side 716. A current sensor 724 may also be located on the second side 716. Advantageously, placement of the voltage sensor 720 and current sensor 724 on the second side 616 of the flyback upstream converter 204 allows sensing of voltage and current on both sides of the transformer 708. For example, when switch 718 is closed, voltage across the first side 712 is reflected to the second side 712 and can be sensed by the voltage sensor 720. When the switch 718 is in the opened, magnetizing current of the transformer 708 flows through the second side 716 can be sensed by the sensing resistor 724. Sensing on both sides of the transformer using a single voltage sensor and current sensor allows a reduction in the number of components required, further lowering costs and space needed.

According to the preferred embodiment of the reduced-energy storage cascaded converter system 200, the downstream converter 216 is a buck converter. For example, the downstream converter output 220 may be connected to a first adder 730, to which is also connected a voltage reference 732. For example, an analog-to-digital converter may be provided between the downstream converter output 220 and the adder 730 such that a digital signal is sent to the adder 730. The voltage reference 732 represents the desired voltage to be provided to the load 224. The output of the first adder is connected to the input of a buck voltage compensator 734. The buck voltage compensator 734 controls a second switch 736 and a third switch 738 for selectively receiving current from the upstream converter 204 and/or the energy storage capacitor 236 being discharged. For example, when switch 736 is closed and switch 738 is open, the downstream converter 216 is receiving energy from the upstream converter 204 and the energy storage capacitor 236. When switch 736 is open and switch 738 is closed, the downstream converter no longer receives energy from the upstream converter 204 or the energy storage capacitor 236 and an output energy storage element 739 discharges to provide energy to the load 224. For example, one or more devices may be used to provide gating signals to the second switch 736 and the third switch 738. For example, the gating signal device may be a pulse width modulator 740. The buck voltage compensator 734 causes the downstream converter 216 to have an effective duty cycle. It will be appreciated that the adder 730, voltage reference 732 and buck voltage compensator together form the downstream controller 226.

The output of the buck voltage compensator 734 is further connected to a second adder 742, to which is also connected a duty cycle reference 744. The duty cycle reference 744 indicates a desired duty cycle for the downstream converter 216. The output of the second adder 742 is connected to an input of a duty mode controller 746 which controls the duty cycle of the upstream converter 204. It will be appreciated that control of the duty cycle of the upstream converter 204 is a function of the duty cycle of the downstream converter 216 and the duty cycle reference 744.

A multiplier 748 may be provided and connected to the second side 716 to receive output voltage information and to the output of the duty mode controller 746. For example an analog to digital converter may be provided to provide a digital signal to the multiplier 748. A third adder 750 may be further provided and connected to the second side 716 to receive output current information and to the output of the multiplier 748. For example an analog to digital converter may also be provided to provide a digital signal to the third adder 740. The combination of the multiplier 748 and third adder 750 is selected to achieve a high power factor correction. A flyback current compensator 752 is coupled the output of the third adder to the switch 718 to control the current or voltage being supplied to the upstream converter 204. For example, a gating signal device, such as a pulse width modulator 754, may be provided to provide a gating signal to the switch. According to some embodiments an optical coupler 756 couples the flyback current compensator 752 to the switch 718 to ensure electrical isolation between the first side 712 and second side 716 while still providing adequate coupling. The combination of the duty mode controller 746 with the flyback current compensator forms an effective upstream controller 226. Each of the first adder 730, voltage reference 732, buck voltage compensator 734, pulse width modulator 740, second adder 742, duty cycle reference 744, duty mode controller 746, multiplier 748, third adder 750, flyback current compensator 752, and pulse width modulator 754 may be implemented digitally such that together these components can be formed within a single integrated circuit, denoted as centralized digital controller 760.

According to some exemplary embodiments, both the flyback upstream converter 204 and the downstream buck converter 216 may be operated in continuous conduction mode in order to reduce peak currents in the reduced energy storage cascaded converter system 200.

According to some exemplary embodiments, to further decrease switching harmonics, an interleaved two phase PFC stage may be implemented. For example, the flyback upstream converter 204 and the downstream buck converter 216 may form a first phase of the two interleaved phases and a second flyback upstream converter and a second downstream buck converter coupled in series with the energy storage element 236 may form a second phase of the two interleaved phases.

While the above exemplary embodiments have been described with respect to a two stage cascaded converter system, it will be appreciated that the design of the reduced energy storage cascaded converter system 200 may be applied to a multistage cascaded converter system. For example, according to such systems, one or more additional converters may be coupled in series upstream of the upstream converter 204. Each of the additional converters will have an associated controller for controlling the duty cycle of current or input being supplied to the input of that additional converter. Furthermore, the input of each of the additional controllers is coupled to the output of the controller associated to, and controlling, the converter that is immediately downstream of the converter to which that additional controller is controlling.

Experimentation Results:

An experimental reduce energy storage cascaded converter system was implemented in various tests. Results of the tests are provided as examples only and are not intended to limit the scope of the embodiments described herein in any way.

According to the experimental reduced-energy storage cascaded converter system, the flyback transformer was chosen in order to meet the following criteria:
The primary coil can be excited with a rectified, universal ac input voltage of 85-265VRMS.
The turns ratio of no more than 1:0.5 to step down the voltage.
A power rating of at least 40W.
Readily available for purchase.

Using this criteria, the flyback transformer chosen was model number Z9260-AL manufactured by Coilcraft®.

According to the experimental reduce energy storage cascaded converter system, the main energy storage capacitor is also the output capacitor of the flyback converter. Electrolytic technology was chosen for this capacitor to reduce the cost of the converter. Since this capacitor has a large ripple voltage on it, it must be designed in accordance with Equation (18). The technical specifications of this capacitor for one phase of the converter are shown in Table I, wherein Pₒᵤₜ is the output power, η_{Buck} is the efficiency of the buck converter, Vₙₒₘᵢₙₐₗ is the nominal V at the capacitor and ΔV_{MAX} is the maximum peak-to-peak voltage.

TABLE 1

| Parameter | Value | Units |
|---|---|---|
| Pₒᵤₜ | 20 | W |
| η_{Buck} | 80 | % |
| Vₙₒₘᵢₙₐₗ | 50 | V |
| ΔV_{MAX} | 15 | V |

Using these specifications, an electrolytic 100 μF capacitor was chosen manufactured by Panasonic®, model number: EEUFCIJ101L. Its specifications are shown in Table II, and they can be substituted into Equation (18). The result of the power it can provide is shown in Equation (20), and is well within the design criteria of Table I with a factor of safety of 1.45. In Table II Iᵣᵢₚₚₗₑ is the ripple of the capacitor. V_{MAX} is the maximum voltage at the capacitor and R_{ESR} is the equivalent series resistance of the capacitor.

$${P}_{dc} = \sqrt{2} {V}_{MAX} {I}_{ripple} - \frac{{I}_{ripple}^{2}}{π {f}_{ripple} C} = 55.36 W \qquad ( 20 )$$

TABLE II

| Parameter | Value | Units |
|---|---|---|
| Iᵣᵢₚₚₗₑ at 120 Hz | 823 | mA |
| V_{MAX} | 63 | V |
| R_{ESR} | 0.230 | Ω |

The capacitor chosen is low cost and readily available. Furthermore, it can handle a relatively large ripple current, which is ideal for the proposed application.

According to the experimental reduce energy storage cascaded converter system, the converter designed in the laboratory has the performance specifications shown in Table III. Technical specifications are shown in Table IV. In Table IV, L^{A} is the inductance of the flyback converter, C^{A} is the capacitance of the flyback converter, V^{A}ₙₒₘᵢₙₐₗ is the nominal voltage at the flyback converter output, and f_{sw} is the switching frequency of the flyback converter. Also L^{B} is the inductance of the buck converter, C^{B} is the capacitance of the flyback converter and f_{sw} is the switching frequency of the flyback converter.

TABLE III

| Input Voltage | 85-265 V_{RMS}, 50-60 Hz |
|---|---|
| Output Voltage | 12 Vdc ± 0.7 V |
| Max. Output Power | 40 W |
| Power Factor | ≧0.98 for loads ≧20 W |
| Interleaved Phases | 2 |

TABLE IV

| | | |
|---|---|---|
| Parameter | Value | Units |

Flyback Converter

| | | |
|---|---|---|
| L^{A} | 0.7 | mH |
| C^{A} | 100 | μF |
| V^{A}ₙₒₘᵢₙₐₗ | 50 | V |
| f_{sw} | 400 | kHz |

Buck Converter

| | | |
|---|---|---|
| L^{B} | 4.7 | μH |
| C^{B} | 47 | μF |
| f_{sw} | 800 | kHz |

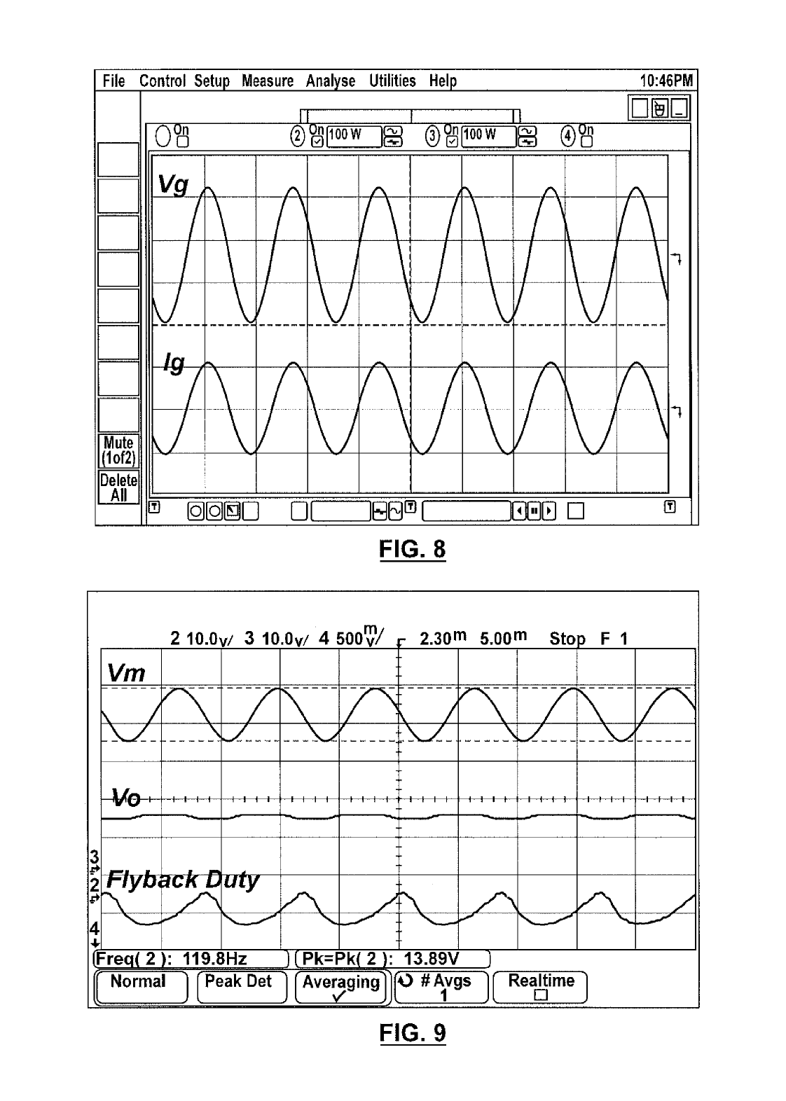

According to the experimental reduce energy storage cascaded converter system, FIG. 8 shows the input voltage and current under full load conditions (40W). The input voltage in this case was set to 110VRMs at 60 Hz. As shown, the converter is operating with excellent power factor correction and in this particular case, the power factor is 0.99. The total harmonic distortion is 7.4%

FIG. 9 shows the voltage on the energy storage capacitor, the output voltage and the duty cycle of the flyback converter for the same load and input voltage conditions as in FIG. 8. In this figure, the large ripple voltage on the capacitor is clearly visible at twice the line frequency. It has a peak to peak voltage of 13.98V, or 31.4% as a percentage of the nominal value. Table V shows the percentage ripple voltage that is obtained at half and full loads for input line frequencies of 50 Hz and 60 Hz. The output voltage also exhibits some ripple, due to the known problem of a limited resolution of the Digital Pulse Width Modulator (DPWM) for the buck converter.

TABLE V

| | 50 Hz | 60 Hz |
|---|---|---|
| 20 W | 23.19% | 19.23% |
| 40 W | 37.06% | 31.44% |

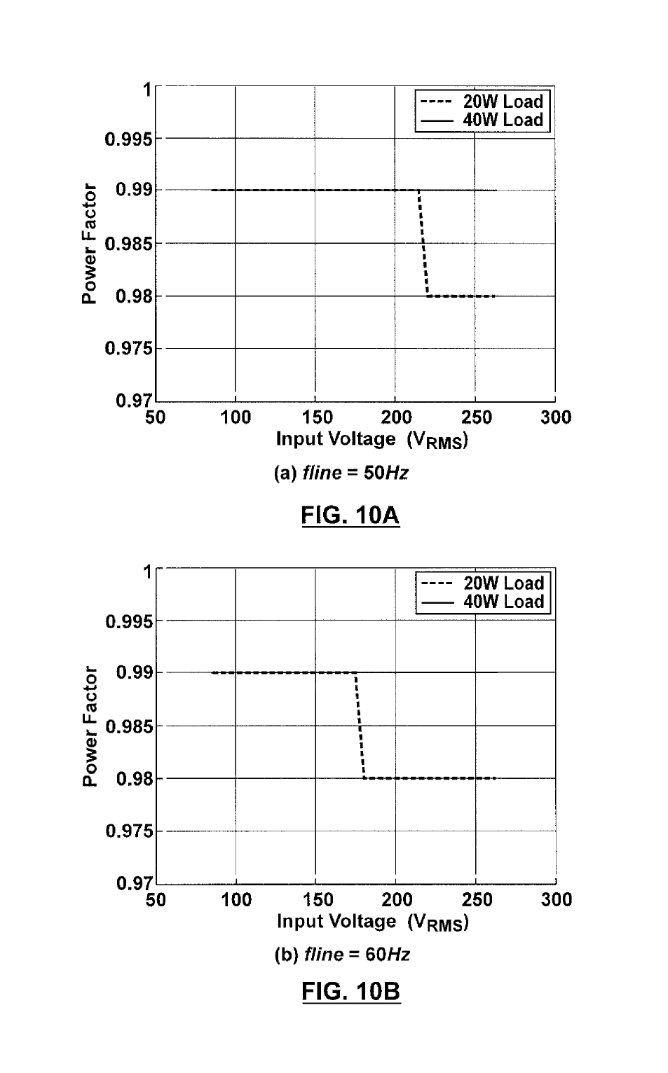

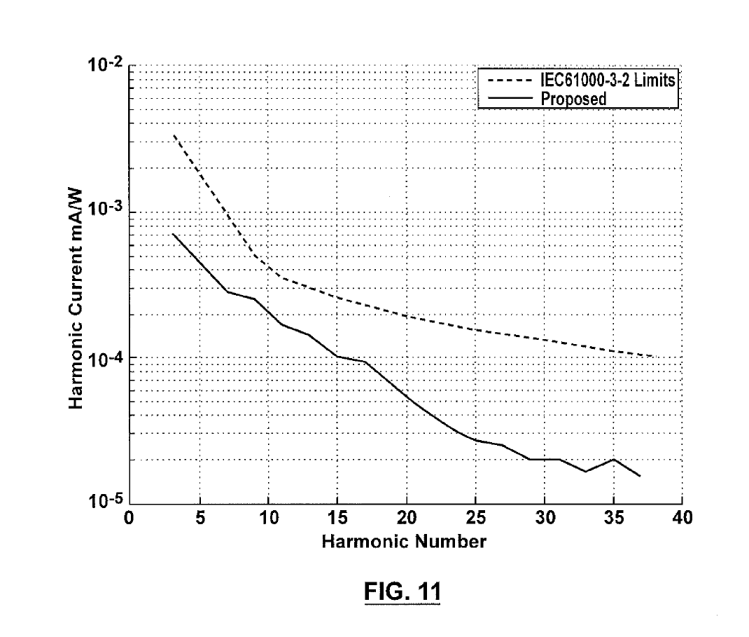

According to the experimental implementation of the reduced energy storage cascaded system, FIGS. 10(a) and 10(b) show the measured power factor. As shown, according to the experimental reduce energy storage cascaded converter system, the converter maintains a power factor of 0.98 or more for all input voltages under full and half load.

In the laboratory, the THD was calculated over the entire input voltage range for both 50 Hz and 60 Hz line frequencies. Using this data, the worst case THD was analysed in depth and is shown in FIG. 11. This Figure shows the worst case odd harmonic content over all loads, input frequencies and voltages plotted against the harmonic current emission limits provided by the IEC61000-3-2 standard. As shown, the converter developed in the laboratory emitted at most half the harmonic current limit as provided by this standard, this minimum occurring at the 9th harmonic current. This also shows that a low cost, PFC supply can be built with sensing on the secondary side that exceeds any input harmonic current standards currently enforced.

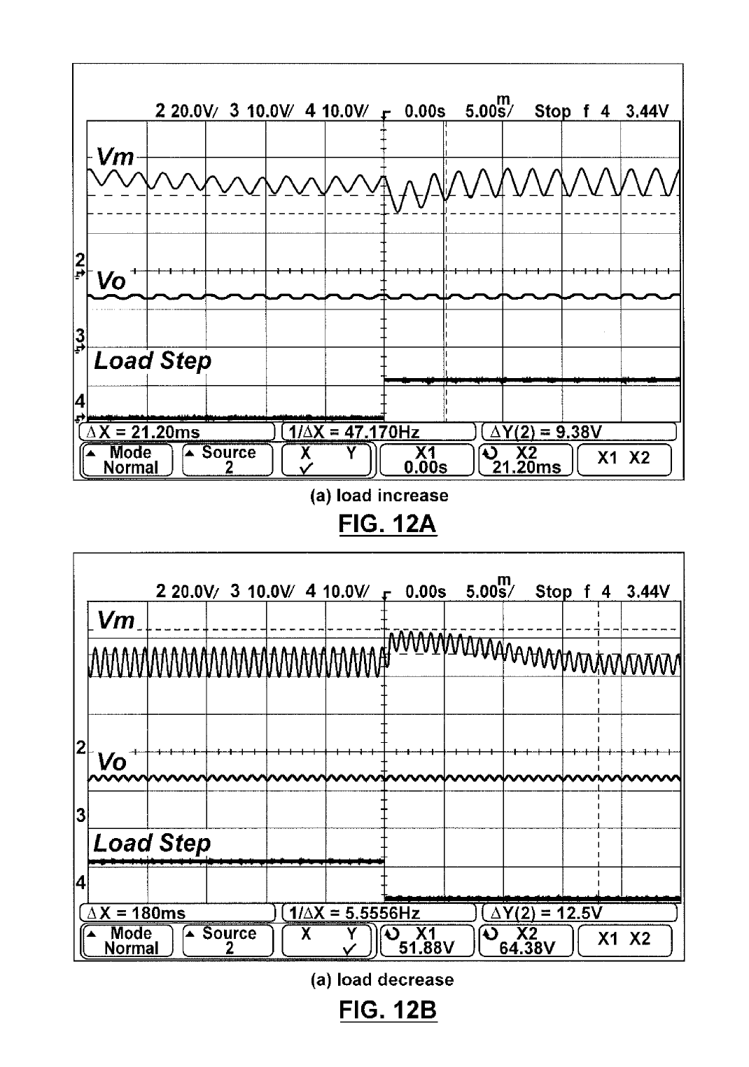

The transient response of the converter was tested with an input voltage of 110VRMs at 60 Hz under a 50% load step from 20W to 40W. FIGS. 12(a) and 12(b) show the results. The downstream buck converter uses voltage mode control, and the upstream flyback pre-regulator uses DMC with a self tuning dead zone controller.

From the figures it is evident that despite the large ripple voltage on the main energy storage capacitor and the little amount of energy stored on it, digital control enabled the development of a suitable controller that can successfully maintain the mid-point voltage of the converter through large load transients.

Table VI shows the energy storage requirements according to experimental implementation of the reduced energy storage cascaded system in comparison to three other PFC supplies supplied by three different manufacturers:

TABLE VI

| Topology | Energy Storage (mJ/W) |
|---|---|
| Proposed | (mJ/W) |
| Boost | 12 |
| Boost | 238 |
| Interleaved Boost | 101 |

As shown, the proposed solution has a significant reduction in energy storage from the conventional solutions. It has up to 19 times less energy storage capacity which translates into a lower cost and smaller size of the converter, as energy storage components significantly contribute to both of these factors. This is a substantial improvement over other topologies and this proposed system has opened new opportunities in PFC design.

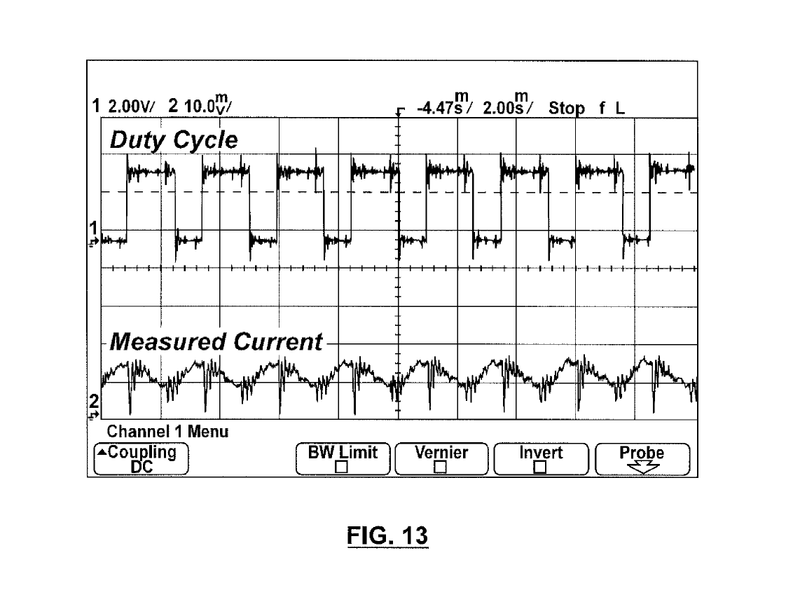

According to the experimental implementation of the reduced energy storage cascaded system, the power factor of the converter decreases at high voltages, when the current is decreased. The main source of harmonic distortion occurs near the zero crossings of the input voltage when the duty cycle is large. This problem can be attributed to the current sensing circuit. FIG. 13 shows the waveform that goes into the current sensing ADC. When the main switch of the flyback converter is switched off, current begins to flow in the secondary winding of the flyback transformer and a voltage is sensed on the current sensing resistor. Due to a small capacitance at this node created by an anti-parallel voltage protection diode, the sensed voltage exhibits an exponential waveform as seen in FIG. 13. Therefore at large duty cycles, the current measurement is not consistent with the actual input current into the converter, and the actual current is much larger than the measured input current. To overcome this limitation, the duty cycle is digitally limited at higher voltages. If it is not, the input current exhibits spikes near the zero crossings of the voltage waveform.

A trade off of the proposed converter is energy storage for a large ripple voltage on the main energy storage capacitor of the system. As a consequence, the ripple current in this capacitor will generate some losses proportional to the ESR of the capacitor. The current in the main energy storage capacitor assuming ideal components can be derived, and is shown in Equation (21).

$${i}_{c} ( t ) = - {P}_{dc} \frac{cos ( 2 ω t )}{\sqrt{\frac{{P}_{dc} sin ( 2 ω t )}{ω C} + {V}_{0}^{2}}} \qquad ( 21 )$$

Using this equation the power lost in the energy storage capacitor, Pc, is determined by Equation (22).

$${P}_{C} = \frac{ω}{2 π} {\int }_{0}^{( 2 π / ω} {i}_{C}^{2} ( t ) {R}_{ESR} d t \qquad ( 22 )$$

Therefore in the worst case scenario where the average efficiency of the buck converter is 70%, the power lost in the main energy storage capacitor can be calculated to be 76.9 mW

This analysis shows that even with a larger ripple current on the main energy storage capacitor, the losses due to this current are very small compared with the output power of the converter. This occurs because typical manufactured capacitors exhibit a direct relationship between energy storage and ESR, as the energy storage decreases, the ESR also decreases.

Hold up time, also known as ride through time, is a converter's ability to provide a continuous output voltage in the event of a temporary fault in the ac voltage. For manufacturers of DC power rectifiers for information technology (IT) applications, there is a standard created by the Information Technology Industry Council (ITIC) which they should adhere to if the voltage sags, swells or is interrupted for a certain period of time. The ITIC recommends that a power supply have a hold up time of at least 20 ms, or one line cycle at 50 Hz. According to the experimental implementation of the reduced energy storage cascaded system the hold up time in the worst case is about 4 ms. However this does not mean the proposed system is not a viable solution. The proposed solution can be implemented for devices that do not require such a stringent hold up time, such as battery powered devices. Furthermore, for inverting applications, the CBEMA curve does not apply.

While the present invention has been described in relation to certain configurations of converters, in general it is expected to be applicable to a wider range of combinations of two or more converters. These converters can be selected from: flyback converter; buck converter; boost converter; buck-boost converter; cuk converter; forward converter; voltage source converter; current course converter; SEPIC converter; parallel resonant converter; and a series Resonant Converter

While the above description provides examples of the embodiments, it will be appreciated that some features and/or functions of the described embodiments are susceptible to modification without departing from the spirit and principles of operation of the described embodiments. Accordingly, what has been described above is intended to be illustrative and non-limiting and it will be understood that other variants and modifications may be made without departing from the scope of the invention as defined in the claims appended hereto.

1. A cascaded converter system comprising:
a first converter;
a second converter coupled in series to the first converter;
a first controller having an input and an output, the input being coupled to an output of the second converter and the output being coupled to an input of the second converter to control the voltage or current being supplied from the output of the second converter;
a second controller having an input and an output, the input of the second controller being coupled to the output of the first controller and the output of the second controller being coupled to the input of the first converter, the second controller controlling the voltage or current being supplied from the output of the first converter.

2. The system of claim 1, wherein the second controller is configured to control the duty cycle of the first converter.

3. The system of claim 1 or 2, wherein the second controller is a duty cycle controller for maintaining the duty cycle of the second converter at a substantially constant reference value.

4. The system of any one of claims 1 to 3, wherein the first controller and the second controller are implemented on the same integrated circuit.

5. The system of any one of claim 1 or 4, wherein the first controller and the second controller are both digital controllers.

6. The system of any one of claims 1 to 5, wherein the second controller controls the duty cycle of the first converter as a function of the duty cycle of the second converter.

7. The system of any one of claims 1 to 6, wherein the second controller responds immediately to a change in duty cycle of the second converter to effect a corresponding change in duty cycle of the first converter.

8. The system of any one of claims 1 to 7, further comprising:
an energy storage device coupled in series between the first converter and the second converter, the energy storage device for providing substantially constant energy to a load coupled to the output of the second converter.

9. The system of claim 8, wherein the second controller controls a change of voltage or current being supplied from the output of the first converter in response to a change in the load step of the load.

10. The system of claim 9, wherein the second controller controls a change of voltage or current being supplied from the output of the first converter in response to a change in the load step of the load substantially faster than a change of voltage or current in the energy storage device in response to the change in the load step.

11. The system of any one of claims 1 to 10, wherein the second converter is a non-isolated DC-DC converter providing load voltage regulation.

12. The system of any one of claims 1 to 11, wherein the first converter is a fly-back converter.

13. The system of any one of claims 1 to 12, wherein the second converter is a buck converter.

14. The system of any one of claim 12 or 13, wherein the fly-back converter provides a high power factor correction.

15. The system of claim 14, wherein the power factor correction is near unity.

16. The system of any one claims 1 to 15, wherein the system further comprises:
a third converter;
a fourth converter coupled in series to the fourth converter,
wherein the system comprises two interleaved phases, the first and second converter forming the first of the two interleaved phases and the third and fourth converter forming the second of the two interleaved phases.

17. The system of any one of claims 1 to 16, wherein the first converter comprises a first side and a second side being in galvanic isolation from the first side.

18. The system of claim 17, wherein the second side of the first converter comprises a voltage sensor for selectably sensing the voltage on the first side and the second side and a current sensor for selectably sensing the voltage on the first and the second side.

19. The system of claim 18, wherein the first converter comprises a transformer and the first side of the first converter comprises a switch coupled in series with windings of the transformer on the first side; and
wherein the switch is set to closed when the voltage sensor senses the voltage on the first side and the switch is set to open when the current sensor senses the current on the first side.

20. The system of any one claim 18 or 19, wherein the second controller controls the voltage or current being supplied to the first converter based on the sensed voltage and the sensed current.

21. The system of any one of claims 1 to 20, wherein the first controller and the second controller operate in continuous conduction mode.

22. The system of any one of claims 1 to 21, wherein the output of the second controller is coupled to the first converter via an optical coupler to provide isolation between the second controller and the first converter.

23. The system of claim 8, wherein the energy storage device is a capacitor.

24. The system of claim 23, wherein the capacitor is a low energy storage capacitor.

25. The system of any one of claim 23 or 24, wherein the capacitor is of a type selected from film, ceramic or electrolytic;

26. The system of any one of claims 23 to 26, wherein at least one of the first or second controller further comprises a filter for filtering voltage ripples in the capacitor while in operation.

27. The system of any one of claims 23 to 27, wherein the first converter, second converter and capacitor are selected such that
$${P}_{dc} \leq \sqrt{2} {V}_{MAX} {I}_{r} - \frac{{I}_{r}^{2}}{π {f}_{r} C}$$
wherein P_{dc} is the power at the output of the second converter, V_{MAX} is the maximum voltage across the capacitor, lᵣ is the RMS current through the capacitor, fᵣ is the frequency of the second harmonic of the system when in operation and C is the capacitance of the capacitor.

28. The system of any one of claims 23 to 27, wherein the first converter, second converter and capacitor are selected such that
$$Δ Q = \frac{\sqrt{2} {I}_{r}}{π {f}_{r}}$$
$$C = \frac{{P}_{dc}}{{V}_{MAX} Δ {V}_{r} π {f}_{r} - {( Δ {V}_{r} )}^{2} π {f}_{r} / 2}$$
wherein C is the capacitance of the capacitor, P_{dc} is the power at the capacitor, V_{MAX} is the maximum voltage across the capacitor, ΔVᵣ is the maximum peak to peak voltage ripple across the capacitor and fᵣ is the frequency of the second harmonic of the system when in operation.

29. The system of one of claims 1 to 28, further comprising:
one or more additional converters coupled in series upstream of the first converter;
one or more additional controllers, each of said additional controllers controlling the voltage or current being supplied to the input of one of the additional controllers, the input of each of the additional controllers being coupled to the output of the controller controlling the converter immediately downstream of the converter to which the additional controller is controlling.

30. A method for controlling a cascaded converter system comprising a first converter and a second converter coupled in series to the first converter, the method comprising:
controlling with a first controller the voltage or current being supplied from the output of the second converter, the second converter having a duty cycle;
controlling with a second controller the voltage or current being supplied from the output of the first converter, the second controller controlling the duty cycle of the first converter as a function of the duty cycle of the second converter.

31. The method of claims 30, wherein the second controller is a duty cycle controller for maintaining the duty cycle of the second converter at a substantially constant reference value.

32. The method of any one of claim 30 or 31, wherein the first controller and the second controller are implemented on the same integrated circuit.

33. The method of any one of claims 30 to 32, wherein the first controller and the second controller are both digital controllers.

34. The method of any one of claims 30 to 33, wherein the second controller responds immediately to a change in duty cycle of the second converter to effect a corresponding change in duty cycle of the first converter.

35. The method of any one of claims 30 to 33, wherein the cascaded converter system further comprises an energy storage device coupled in series between the first converter and the second converter, the energy device for providing substantially constant energy to a load coupled to the output of the second converter; and wherein the second controller controls a change of voltage or current being supplied from the output of the first converter in response to a change in the load step of the load.

36. The system of claim 35, wherein the second controller controls a change of voltage or current being supplied from the output of the first converter in response to a change in the load step of the load substantially faster than a change of voltage or current in the energy storage device in response to the change in the load step.
